(19) United States
(12) Patent Application Publication
(10) Pub. No.: US 2025/0300901 A1
(43) Pub. Date: Sep. 25, 2025

(54) DISTRIBUTED LEARNING PROCESSES

(71) Applicant: Telefonaktiebolaget LM Ericsson (publ), Stockholm (SE)

(72) Inventors: Hossein SHOKRI GHADIKOLAEI, Solna (SE); Martin ISAKSSON, Stockholm (SE); Johan HARALDSON, Stockholm (SE); Rafia INAM, Västerås (SE)

(21) Appl. No.: 18/863,414

(22) PCT Filed: May 11, 2022
(86) PCT No.: PCT/EP2022/062754

§ 371 Date: Nov. 6, 2024

(51) Int. Cl. H04L 41/16; H04L 41/14

(52) U.S. Cl. CPC H04L 41/16; H04L 41/145

(57) ABSTRACT

A method performed by a first client node in a communications network. The first client node acts as a worker in a distributed machine learning process for training a model. The training is co-ordinated by a server node that acts as a master in the distributed machine learning process. The method includes: performing a first epoch of training on a first local copy of the model to obtain a first update to the model; performing a second epoch of training on a second local copy of the model to obtain a second update to the model; determining an accumulated error associated with differences between values of one or more parameters of the model between the first epoch and the second epoch of training; and using the accumulated error to determine whether to send the second update to the model to the server node.

### TECHNICAL FIELD

This disclosure relates to methods, nodes and systems in a communications network. More particularly but non-exclusively, the disclosure relates to training a model using a distributed learning process in a communications network.

### BACKGROUND

Machine learning (ML) has revolutionized many science and technology fields, thanks to large platforms with vast amounts of dedicated computational and communication resources. There is a growing interest in applying ML to general networks artificial intelligence (AI) where the datasets and ML tasks are distributed and connected over public communication networks such as Internet of Things (IoT) or 5G. These interests are pushing the intelligence to the network edge, meaning that the data is processed locally in algorithms stored on a hardware client. It enables real-time operations and helps to significantly reduce the power consumption and security vulnerability associated with processing data in the cloud. Internet of senses and metaverse are among the examples that require network automations among massive numbers of clients, for which data collection and machine learning (ML) are necessary. Further, there can be real-time requirements for the applications using this data which means that data needs to be gathered and processed in a very short time (e.g. in orders of some ms).

Distributed Learning (DL) (otherwise referred to as distributed machine learning) methods are used to train ML models on data stored at a plurality of client sites without having to move the data to a central location. Thus, DL methods may better preserve the privacy of local data. As illustrated in FIG. 1, In most distributed AI settings, a plurality of client nodes 100 train (in step 2 of FIG. 1) a local copy of the model on local data and communicate (in step 3 of FIG. 1) in uplink their local parameters to a server node 102 (which may otherwise be referred to as a parameter server) which aggregates (step 4 in FIG. 1) the local updates into a global version of the model parameters and shares (step 1 of FIG. 1) it afterward with the client nodes 100 in a downlink channel. In a hierarchical DL method, there may be a plurality of server nodes 102. This process is repeated until the model converges. Examples of DL include, for example, Federated Learning (FL) and split learning.

FL is a prominent distributed learning algorithm in which a random subset of the plurality of client nodes, e.g. a fraction C out of all N clients, are selected at every iteration to provide updates to the model to the server node, and their messages are used to update the global model that is then distributed to the client nodes in the next epoch of training.

### SUMMARY

As noted above, every iteration of training (otherwise referred to as an “epoch” of training) involves local computations at each client node followed by the communication of messages in both uplink and downlink. Furthermore, often many iterations of training are performed in order to converge on a stable and usable model. Sending updated parameters at each iteration represents high computational overhead, particularly if the model is large, comprising many parameters.

However, many of these uplink messages are redundant carrying almost no additional information. Current methods are largely based on a predefined schedule, which, as noted above, may select which client nodes are to update their parameters in an arbitrary manner. It is an object of embodiments herein to improve upon these methods.

According to a first aspect herein there is a computer implemented method performed by a first client node in a communications network, wherein the first client node acts as a worker in a distributed machine learning process for training a model, wherein the training is co-ordinated by a server node that acts as a master in the distributed machine learning process. The method comprises: performing a first epoch of training on a first local copy of the model received from the server node to obtain a first update to the model; performing a second epoch of training on a second local copy of the model received from the server node to obtain a second update to the model; determining an accumulated error associated with differences between values of one or more parameters of the model between the first epoch and the second epoch of training; and using the accumulated error to determine whether to send the second update to the model to the server node.

According to a second aspect there is a computer implemented method performed by a server node in a communications network, wherein the server node acts as a master in a distributed machine learning process for training a model, and co-ordinates training of the model amongst a plurality of client nodes that act as workers in the distributed machine learning process. The method comprises: instructing a first client node to perform a first epoch of training on a first local copy of the model to obtain a first update to the model; instructing the first client node to perform a second epoch of training on a second local copy of the model to obtain a second update to the model; and receiving the second update to the model from the first client node if an accumulated error associated with differences between values of one or more parameters of the model between the first epoch and the second epoch of training is greater than a first threshold.

According to a third aspect there is a method performed by a Network Data Analytics Function, NWDAF, node in a communications network, as part of a distributed machine learning process for training a model, wherein the training is co-ordinated by a server node that acts as a master in the distributed machine learning process and co-ordinates the training in a plurality of client nodes that act as workers in the distributed machine learning process. The method comprises: receiving from a first client node, an accumulated error associated with differences between values of one or more parameters of the model between a first epoch of training and a second epoch of training performed by the first client node; and using the accumulated error to determine whether to instruct the first client node to send the second update to the model to the server node.

According to a fourth aspect there is a first client node in a communications network wherein the first client node acts as a worker in a distributed machine learning process for training a model, wherein the training is co-ordinated by a server node that acts as a master in the distributed machine learning process. The first client node comprises: a memory comprising instruction data representing a set of instructions; and a processor configured to communicate with the memory and to execute the set of instructions. The set of instructions, when executed by the processor, cause the processor to: perform a first epoch of training on a first local copy of the model received from the server node to obtain a first update to the model; perform a second epoch of training on a second local copy of the model received from the server node to obtain a second update to the model; determine an accumulated error associated with differences between values of one or more parameters of the model between the first epoch and the second epoch of training; and use the accumulated error to determine whether to send the second update to the model to the server node.

According to a fifth aspect there is a first client node in a communications network, wherein the first client node acts as a worker in a distributed machine learning process for training a model, wherein the training is co-ordinated by a server node that acts as a master in the distributed machine learning process, and wherein the first client node is configured to: perform a first epoch of training on a first local copy of the model received from the server node to obtain a first update to the model; perform a second epoch of training on a second local copy of the model received from the server node to obtain a second update to the model; determine an accumulated error associated with differences between values of one or more parameters of the model between the first epoch and the second epoch of training; and use the accumulated error to determine whether to send the second update to the model to the server node.

According to a sixth aspect there is a server node in a communications network, wherein the server node acts as a master in a distributed machine learning process for training a model, and co-ordinates training of the model amongst a plurality of client nodes that act as workers in the distributed machine learning process. The server node comprises: a memory comprising instruction data representing a set of instructions; and a processor configured to communicate with the memory and to execute the set of instructions, wherein the set of instructions, when executed by the processor, cause the processor to: instruct a first client node to perform a first epoch of training on a first local copy of the model to obtain a first update to the model; instruct the first client node to perform a second epoch of training on a second local copy of the model to obtain a second update to the model; and receive the second update to the model from the first client node if an accumulated error associated with differences between values of one or more parameters of the model between the first epoch and the second epoch of training is greater than a first threshold.

According to a seventh aspect there is a server node in a communications network, wherein the server node acts as a master in a distributed machine learning process for training a model, and co-ordinates training of the model amongst a plurality of client nodes that act as workers in the distributed machine learning process, and wherein the server node is configured to: instruct a first client node to perform a first epoch of training on a first local copy of the model to obtain a first update to the model; instruct the first client node to perform a second epoch of training on a second local copy of the model to obtain a second update to the model; and receive the second update to the model from the first client node if an accumulated error associated with differences between values of one or more parameters of the model between the first epoch and the second epoch of training is greater than a first threshold.

According to an eighth aspect there is a Network Data Analytics Function, NWDAF, in a communications network, wherein the NWDAF acts as part of a distributed machine learning process for training a model, wherein the training is co-ordinated by a server node that acts as a master in the distributed machine learning process and co-ordinates the training in a plurality of client nodes that act as workers in the distributed machine learning process. The NWDAF comprises: a memory comprising instruction data representing a set of instructions; and a processor configured to communicate with the memory and to execute the set of instructions. The set of instructions, when executed by the processor, cause the processor to: receive from a first client node, an accumulated error associated with differences between values of one or more parameters of the model between a first epoch of training and a second epoch of training performed by the first client node; and use the accumulated error to determine whether to instruct the first client node to send the second update to the model to the server node.

According to a ninth aspect there is a Network Data Analytics Function, NWDAF, in a communications network, wherein the NWDAF acts as part of a distributed machine learning process for training a model, wherein the training is co-ordinated by a server node that acts as a master in the distributed machine learning process and co-ordinates the training in a plurality of client nodes that act as workers in the distributed machine learning process. The NWDAF is configured to: receive from a first client node, an accumulated error associated with differences between values of one or more parameters of the model between a first epoch of training and a second epoch of training performed by the first client node; and use the accumulated error to determine whether to instruct the first client node to send the second update to the model to the server node.

According to a tenth aspect there is a computer program comprising instructions which, when executed on at least one processor, cause the at least one processor to carry out a method according to any of the first, second or third aspects.

According to an eleventh aspect there is a carrier containing a computer program according to the tenth aspect, wherein the carrier comprises one of an electronic signal, optical signal, radio signal or computer readable storage medium.

According to a twelfth aspect there is a computer program product comprising non transitory computer readable media having stored thereon a computer program according to the tenth aspect.

Thus, embodiments herein allow client nodes in a distributed learning method to determine whether to send their updates to the server node, dependent on an accumulated error between the results of different epochs of training at the client node. Thus, in this way, the method takes the importance of local data into account when determining which client nodes are to provide updates to the server node. This results in fewer uploads which reduces the time involved for each global iteration (as the server node will not need to wait unnecessarily for less important information), reduces interference/congestion level and network resource utilization in the uplink, increases robustness to stragglers and reduces energy consumption of the client. Thus, the methods and systems herein provide a manner in which to perform intermittent communications in DL systems, for more efficient edge learning.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 illustrates a prior art distributed learning method;

FIG. 2 shows a first client node according to some embodiments herein;

FIG. 3 shows a method in a first client node according to some embodiments herein;

FIGS. 4a, b, and c show examples of objective functions according to some embodiments herein;

FIG. 5 shows a NWDAF;

FIG. 6 shows a method in a NWDAF according to some embodiments herein;

FIG. 7 shows a server node according to some embodiments herein;

FIG. 8 shows a method in a server node according to some embodiments herein;

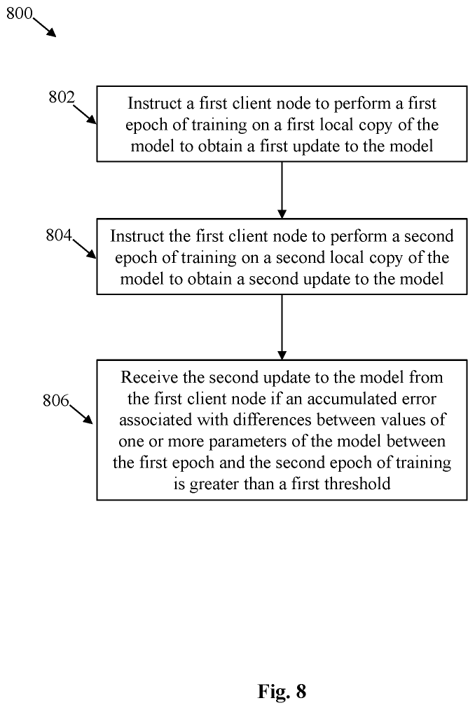

FIG. 9 shows an example signal diagram according to some embodiments herein; and

FIG. 10 shows an example signal diagram according to some embodiments herein

### DETAILED DESCRIPTION

As described above, many current DL systems tend to ignore the importance of local data and/or channel conditions and/or resources (computational, battery, etc.) available at a client when deciding which client nodes are to send their updates to the server node. This can lead to excessive computational overhead. Furthermore, when all client nodes (or a random subset of client nodes) send updates, some client nodes may not send information that improves the model (e.g. if the parameter values are very similar to what was sent previously or to the current values of the global model), thus the computational overhead is wasted and the process suboptimal.

Ignoring channel conditions or computational resources leads to suboptimal design, which is problematic If the AI system is to coexist with underlying communication services. For example, it might be that the entire algorithm sees extra latency if e.g. a participating client in poor radio or network conditions tries to retransmit multiple times or, if said client has very little computational/memory/power/communication resources or experiences high load and therefore cannot upload its data in time.

Some DL methods to solve these problems only apply to very specific classes of algorithms or problems, which make them impractical in future internet of senses use cases.

The systems and methods disclosed herein describe methods whereby clients may skip unnecessary uploads at each iteration of training. This is done by estimating parameters such as (1) a local decision on the importance of every client's data (to be uploaded) to the global optimization problem, (2) channel conditions (in case of wireless communications, but also can be adapted to wired communications through the channel transmission rate), and/or (3) local available resources (computation, power, communication).

In some embodiments, client nodes herein determine an accumulated error associated with differences in local parameter values between two or more epochs of training on local copies of the global model. The client uses the accumulated error to determine whether to send an update to the model to the server node.

This allows for an automated approach to picking clients with updates that are significant to the global model as the clients who are to send their updates to the server in each epoch of training. Thus, the approach herein addresses “which clients should upload” by considering statistical correlation of the nodes' data and the importance of their new data to the global optimization problem, using a local upload trigger, implemented in the client, based on local measurements.

While some approaches are designed (and perhaps only work) for FL, the methods described herein can work for any distributed optimization technique (including but not limited to cross-device and cross-silo FL and split learning).

In more detail, the disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

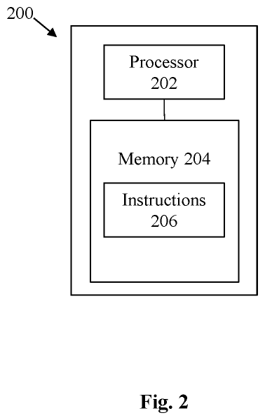

FIG. 2 illustrates a first client node 200 in a communications network according to some embodiments herein. Generally, the first client node 200 may comprise any component or network function (e.g. any hardware or software module) in the communications network suitable for performing the functions described herein.

For example, a client node may comprise equipment capable, configured, arranged and/or operable to communicate directly or indirectly with other network nodes or equipment in the communications network in order to receive wireless or wired access in the communications network.

In more detail, a client node may be a wireless device or User Equipment (UE). A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. AUE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal. Thus, in general, the first client node may be an IoT device.

A client node may also refer to a network node. Examples of network nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

These are merely examples however and it will be appreciated that the first client node may equally be any other node in the communications network that can perform the functions described herein.

The first client node 200 is configured (e.g. adapted, operative, or programmed) to perform any of the embodiments of the method 300 as described below. It will be appreciated that the first client node 200 may comprise one or more virtual machines running different software and/or processes. The first client node 200 may therefore comprise one or more servers, switches and/or storage devices and/or may comprise cloud computing infrastructure or infrastructure configured to perform in a distributed manner, that runs the software and/or processes.

The first client node 200 may comprise a processor (e.g. processing circuitry or logic) 202. The processor 202 may control the operation of the first client node 200 in the manner described herein. The processor 202 can comprise one or more processors, processing units, multi-core processors or modules that are configured or programmed to control the first client node 200 in the manner described herein. In particular implementations, the processor 202 can comprise a plurality of software and/or hardware modules that are each configured to perform, or are for performing, individual or multiple steps of the functionality of the first client node 200 as described herein.

The first client node 200 may comprise a memory 204. In some embodiments, the memory 204 of the first client node 200 can be configured to store program code or instructions 206 that can be executed by the processor 202 of the first client node 200 to perform the functionality described herein. Alternatively or in addition, the memory 204 of the first client node 200, can be configured to store any requests, resources, information, data, signals, or similar that are described herein. The processor 202 of the first client node 200 may be configured to control the memory 204 of the first client node 200 to store any requests, resources, information, data, signals, or similar that are described herein.

It will be appreciated that the first client node 200 may comprise other components in addition or alternatively to those indicated in FIG. 2. For example, in some embodiments, the first client node 200 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 202 of first client node 200 may be configured to control such a communications interface to transmit to and/or receive from other nodes or network functions requests, resources, information, data, signals, or similar.

Briefly, in one embodiment, the first client node 200 acts as a worker in a distributed machine learning process for training a model, wherein the training is co-ordinated by a server node that acts as a master in the distributed machine learning process. The first client node 200 is configured to: perform a first epoch of training on a first local copy of the model received from the server node, to obtain a first update to the model; perform a second epoch of training on a second local copy of the model received from the server node to obtain a second update to the model, determine an accumulated error associated with differences between values of one or more parameters of the model between the first epoch and the second epoch of training, and use the accumulated error to determine whether to send the second update to the model to the server node.

The skilled person will be familiar with distributed machine learning processes, such as, for example Federated Learning and Split Learning. See, for example, the paper by Singh, Abhishek, Praneeth Vepakomma, Otkrist Gupta, and Ramesh Raskar, entitled: “Detailed comparison of communication efficiency of split learning and federated learning.” arXiv preprint arXiv:1909.09145 (2019).

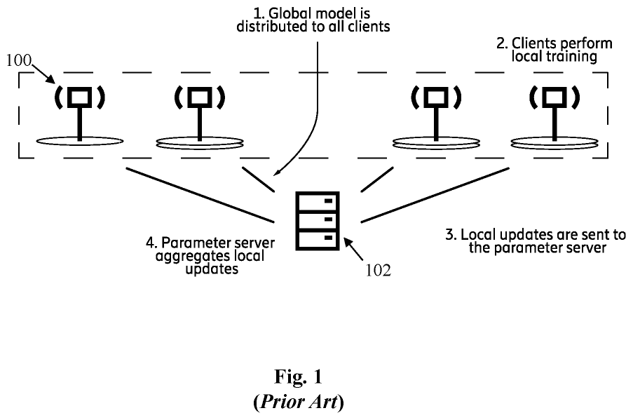

Briefly, as illustrated in FIG. 1, a distributed ML process is co-ordinated by a server node (or server nodes). The server node may be referred to as a master node in the distributed ML process. The server node co-ordinates the training of a model at a plurality of client nodes. The first client node is one of the plurality of client nodes. The plurality of client nodes may act as worker nodes (otherwise known as slave nodes) in the distributed learning process.

The model may be any type of model that can be trained using a distributed learning process. Examples of models that may be trained include, but are not limited to supervised ML models such as neural network models, convolutional neural network models, random forest models, Support Vector Machine (SVM) models, or any other type of model that can be trained in a distributed manner. The model may also be a model associated with unsupervised learning, such as k-means clustering tasks, as well as reinforcement learning, in which the computations can be distributed among multiple client nodes, for example multi-agent reinforcement learning.

The server node holds a global copy of the model. The global copy represents the aggregation or cumulative learning that has taken place across the plurality of client nodes. As described with respect to FIG. 1 above, the server node sends information to the first client node and the other nodes of the plurality of client nodes to enable each client node to create a local copy of the model thereon. The first client node 200 then trains the local copy of the model on its local data (e.g. without the need to send data to the server node) and obtains an update to the model. The update may be, for example, updated parameter values of the model obtained as a result of the local training. In embodiments herein, the client node then uses the method 300 as described below to determine whether to send the update to the server node for aggregation into the global copy of the model.

As used herein, a global iteration or global epoch of training refers to a cycle of the server node sending out instructions to the plurality of client nodes to perform training on local copies of the model, receiving updates from the plurality of client nodes based on the local training and aggregating the results into the global copy of the model.

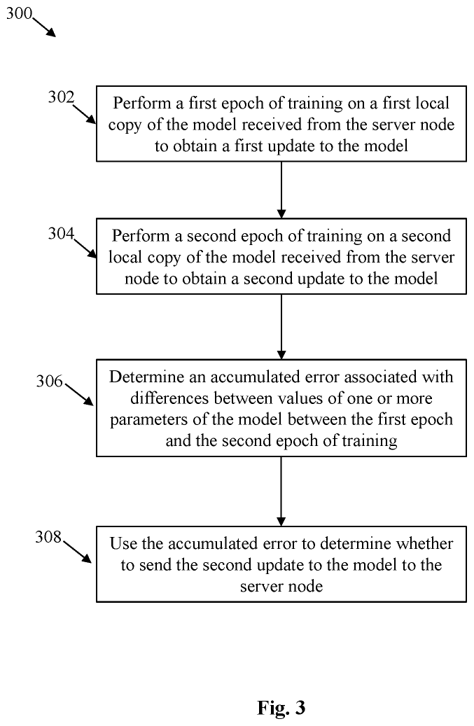

As noted above, the first client node performs the method 300 illustrated in FIG. 3. Briefly, in a first step 302, the method 300 comprises: performing a first epoch of training on a first local copy of the model received from the server node to obtain a first update to the model. In a second step 304, the method 300 comprises: performing a second epoch of training on a second local copy of the model received from the server node to obtain a second update to the model. In a third step, the method 300 comprises: determining an accumulated error associated with differences between values of one or more parameters of the model between the first epoch and the second epoch of training; and in a fourth step the method 300 comprises: using the accumulated error to determine whether to send the second update to the model to the server node.

In step 302 may further comprise receiving first instructions from the server, to create a first local copy of the model. The first client node may then create the first local copy of the model and perform the first epoch of training on the model.

The first epoch of training (which may alternatively be described as a first iteration of training) may be performed as instructed by the server node, in the known manner. The skilled person will be familiar with ways of training machine learning models, for example, neural networks may be trained using techniques such as gradient descent and back-propagation. This is merely an example however and the first client node may train the model using any suitable technique in the art.

The first epoch of training may be performed using training data stored or accessible to the first client node 200.

As a result of the first epoch of training, the first client node obtains a first update to the model. The first update comprises the outcome (e.g. learnings) of the first epoch of training performed by the first client node 200. The first update may, for example, indicate new values (or changes in values compared to those sent by the server node) of one or more parameters of the model.

In step 304, the first client node may receive second instructions from the server, to create a second local copy of the model. The first client node may then create the second local copy of the model and perform a second epoch of training on the second local copy of the model to obtain a second update to the model.

The second epoch of training may be performed as instructed by the server node, in the same manner or a different manner to the first epoch of training.

In step 304 the method comprises determining (304) an accumulated error associated with differences between values of one or more parameters of the model between the first epoch and the second epoch of training.

The accumulated error may represent the accumulated error that would be accrued if the first client node were silent and did not upload the second update to the server node. As such, the accumulated error may represent a local model/gradient drift compared to the last time that the first client uploaded its update.

In this way, the first client is able to determine the importance of the second update (e.g. its new data—gradient or parameters to be uploaded) to the global optimization problem.

In some embodiments, the accumulated error is a vector aggregation of values of the one or more parameters obtained as a result of the first epoch of training and the second epoch of training. The vector aggregation may further comprise an aggregation of values of the one or more parameters obtained as a result of one or more other epochs of training, preceding the first epoch of training, since the first client node last sent an update to the server as part of the distributed learning process.

In some embodiments, the accumulated error associated with the first epoch of training, e_{i,t}, is set to: zero, if following the first epoch of training, the first client node sends the first update to the model to the server node; or to w_{i,t}, if following the first epoch of training, the first client node does not send the first update to the model to the server node. In this example, w_{i,t} are the values (e.g. a vector of values) of the one or more parameters of the local copy of the model following the first epoch of training. In other words, every time the first client node 200 uploads the first update, then the accumulated error may be set to zero. If the first update associated with the first epoch of training is not uploaded, then the accumulated error may be set to a vector of the parameter values of the first update.

Following the second epoch of training, the accumulated error associated with the second epoch of training, e_{i,t+1}, may be set to: zero, if following the second epoch of training, the first client node sends the second update to the model to the server node; or to e_{i,t+1}=e_{i,t}+w_{i,t+1} if, following the second epoch of training, the first client node does not send the first update to the model to the server node. In this example, w_{i,t+1} are the values of the one or more parameters of the local copy of the model following the second epoch of training. Thus in this manner, the error accumulates with each round of training for which the update is not sent to the server.

In more detail, as an example, let w_{i,t} be the parameter of client i at iteration t, wₜ be the global parameter at iteration t, and let e_{i,t} denote the accumulated error of client i at iteration t, which aggregates the consecutive parameters that the client did not upload so far. We have e_{i,o}=0, a vector of zero values. Then, the accumulated error is updated as follows:

$${e}_{i , t + 1} = \{ \begin{matrix}0 & if client i uploads at iteration t + 1 \\ {e}_{i , t} + {w}_{i , t + 1} & otherwise\end{matrix}$$

In some embodiments, the method may further comprise sending the second update to the model to the server node based on a distance measure between the values of the one or more parameters of the local model after the first epoch of training and the one or more parameters of the local model after the second epoch of training. In other words, alternatively or additionally to the accumulated error described above, the first client node 200 may use a distance measure to measure the distance of the local model/gradients with the global one. Examples of distance measures include e.g., Euclidian norm, norm 2, but could also be other distance measures like other norms or KL divergence, Earth Movers Distance etc. It will be appreciated that these are merely examples of distance measures and that other distance measures may equally be used.

As an example, the distance measure may be ∥w_{i,t+1}−w_{i,t}∥, wherein w_{i,t+1} are the values of the one or more parameters of the model following the second epoch of training and w_{i,t} are the values of the one or more parameters of the model following the first epoch of training. In this example, ∥w_{i,t+1}−w_{i,t}∥, refers to the norm 2 of vector w_{i,t+1}−w_{i,t}, (but note that as above, norm 2 can be changed to other distance measures like other norms or KL divergence).

As noted above, in step 306, the method 300 comprises using the accumulated error to determine whether to send the second update to the model to the server node.

In some embodiments, this step may comprise the sending the second update to the model to the server node if the accumulated error is greater than a first threshold. For example, sending the second update to the server node if ∥e_{i,t}∥≥βₜ₊₁_{¹}, wherein βₜ₊₁ represents the first threshold.

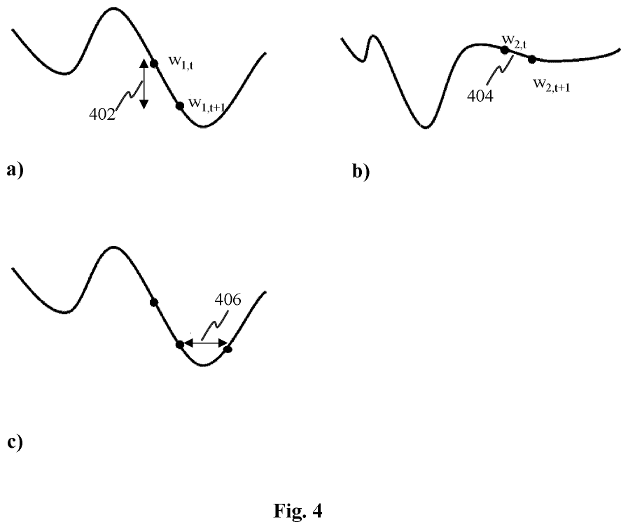

FIG. 4a illustrates an objective function (otherwise known as a loss function). The criteria ∥e_{i,t}∥≥βₜ₊₁ may be used to pick out those updates representing a sequence of small changes in gradient 402 after some epochs of training. In particular, the changes of the gradient/parameter in every epoch, compared to that of the previous epoch, could be small, but a sequence of those small changes may lead to a big error e_{i,t}.

In some embodiments, this step may further comprise sending the second update to the model to the server node if the distance measure (described above) is greater than a second threshold. For example, sending the second update to the server node if ∥w_{i,t+1}−w_{i,t}∥≥αₜ₊₁ wherein αₜ₊₁ represents the second threshold. This update forces an upload whenever a big change in the model parameter is detected,

As illustrated in FIG. 4c, this criteria may be used to pick out those updates where despite, the absolute values of the parameters being quite similar, the local training has converged on a different part of the objective function (e.g. across a local minima). Although the gradient may be low, the absolute change in values is high, as illustrated by arrow 406.

Higher αₜ₊₁ or βₜ₊₁ means less uploads but may endanger the convergence of the algorithm. Lower α or β increases the communication overhead, but also improves the convergence, as more clients will likely upload their data at every iteration. In extreme case of α₁=α₂= . . . αₜ=0 or β₁=β₂= . . . =βₜ=0, all clients may participate and upload their data in every iteration. Condition e_{i,t}≥βₜ₊₁ guarantees that the client will eventually upload its data even if its local model stays within a bounded region of the global model for many iterations. This is particularly important for non-IID datasets where the models/gradients of client i may be needed for the global convergence.

The first and/or second thresholds may be set dynamically by the server node, for example, after each epoch of training. In this way, the server node is able to control the level of the accumulated error and/or the level of the distance measure at which clients send uploads. The first and/or second thresholds may be received, for example, in a message from the server node. For example, the first and/or second thresholds may be received in the same message as that containing the instructions relating to the manner in which the first client node is to perform the first epoch of training.

In more detail, for epoch t+1, for each client node i, the following rules may be used to determine whether the update should be uploaded to the server:

$$\{ \begin{matrix}upload {w}_{i , t + 1} & if server node requests the update \\ upload {w}_{i , t + 1} & ‖ {w}_{i , t + 1} - {w}_{i , t} ‖ \geq {α}_{t + 1} \\ upload {w}_{i , t + 1} & ‖ {e}_{i , t} ‖ \geq {β}_{t + 1} \\ do not upload & otherwise\end{matrix}$$

In this example, as well as using the accumulated error and distance measures, the first client node may also send the second update to the model to the server node in response to a request from the server node for the second update.

Thus, in this way, local information is taken into account when the client node determines whether to upload the second update. This works and still ends up with high quality training of the model due to the local smoothness of most objective functions (otherwise known as loss functions) used for the training (which manifests itself in the combination of local data and the local geometry of the optimization landscape at an iteration). The global training algorithm may tolerate updating the global parameter based on some outdated parameters/gradients of some clients. Objective function could be, for instance, cross entropy in classification or mean squared error in regression, whose exact shape may depend on the local data.

As an example of the importance of local geometry, consider a simple FL with two clients, where w_{i,j} shows parameter of client i at global iteration j. The server updates the global model at iteration j by (w_{1,j}+w_{2,j})/2. FIG. 4a and FIG. 4b shows the optimization landscape of two clients. The difference in shape corresponds to difference in the local data as well as potentially different local objective functions. Locally where the iterations evolve, optimization landscape of client 2 (FIG. 4b) is smoother than that of client 1 (in FIG. 4a), meaning that (in this example w_{2,t+1} is closer to w_{2,t} than w_{1,t+1} to w_{1,t}). When

$$\frac{{w}_{1 , t + 1} + {w}_{2 , t + 1}}{2} \approx \frac{{w}_{1 , t + 1} + {w}_{2 , t}}{2}$$

client 2 can skip uploading w_{2,t+1} at iteration t+1 without greatly harming the global updates. This is more likely to happen than

$$\frac{{w}_{1 , t + 1} + {w}_{2 , t + 1}}{2} \approx \frac{{w}_{1 , t} + {w}_{2 , t + 1}}{2}$$

due to smother landscape of client 2, locally where the iterations evolve.

Thus, when the update from a client is not very important for the global model update (as evaluated using steps 306 and 308), and that device does not have a good transmission rate (e.g., due to fading or blockage or lack of enough power or high interference around that client), the information of that client in that iteration may me skipped (e.g. not be transmitted), and the global model may be updated based on previous information sent by that client. Skipping those less important uploads by forcing some clients to be silent in some iterations can bring substantial gains in terms of network resource utilization and energy saving in use cases when (a) we have many clients participating in distributed training or (b) we have big models or big messages that we should upload in every iteration, or/and (c) we need many iterations to converge.

Turning back to the method 300, in some embodiments, the first client node determines whether it should upload the second update to the server node, for example, using the first and second thresholds and the criteria described above. In other embodiments, the first client node may send the accumulated error and/or the distance measure to a second node and the second node may determine, from the accumulated error and/or the distance measure whether the first client node should send the update to the client node. In some examples, the second node is a Network Data Analytics Function, NWDAF, node in a communications network. It will be appreciated that this is merely an example and that the second node could equally be other nodes.

Thus, in some embodiments where the second node is a NWDAF, the method 300 further comprises sending the accumulated error to the NWDAF node in the communications network; and receiving from the NWDAF node, an indication of whether the first client node should send the second update to the model to the server node based on the accumulated error.

The method may further comprise sending a distance measure between the values of the one or more parameters of the local model after the first epoch of training and the one or more parameters of the local model after the second epoch of training to a Network Data Analytics Function, NWDAF node in the communications network; and receiving from the NWDAF node, an indication of whether the first client node should send the second update to the model to the server node, based on the distance measure.

Even if a second node, such as a NWDAF is used, this still results in fewer messages of smaller size being sent across the network compared to the first client node sending the first, second and subsequent updates to the server node each time, irrespective of the respective updates value to the global optimisation problem.

In this way, the methods herein provide “local” upload trigger mechanisms and intelligence that can reside in the client/UE, as opposed to the highly centralized approaches of previous methods. In the method highlighted above, the client nodes consider how important the update of this client is for this iteration of the global optimization algorithm at the server node(s). Since every user weights the importance of its update (which includes the geometry of the optimization problem, local data, previously sent parameter), the solutions herein can be more efficient in determining if a client input is really necessary for the next global iteration.

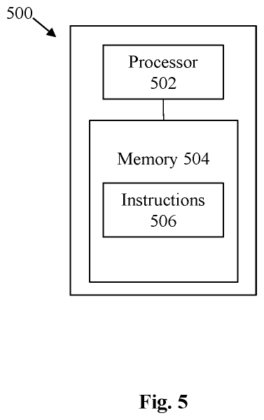

Turning now to other embodiments, FIG. 5 illustrates a NWDAF according to some embodiments herein. The NWDAF comprises a processor, 502, a memory 504. The memory comprises instruction data representing a set of instructions 506. The processor is configured to communicate with the memory and to execute the set of instructions. The set of instructions, when executed by the processor, may cause the processor to perform the method 600 described below.

Processors, memories and instructions were all described above with respect to the first client node 200 and the detail therein will be appreciated to apply equally to the processor 502, memory 504 and instructions 506.

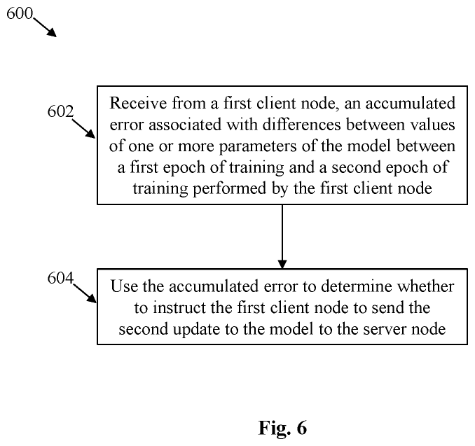

A NWDAF may be configured to perform the method 600 illustrated in FIG. 6. The method 600 may be performed by a NWDAF node in a communications network, as part of a distributed machine learning process for training a model, whereby the training is co-ordinated by a server node that acts as a master in the distributed machine learning process and co-ordinates the training in a plurality of client nodes that act as workers in the distributed machine learning process.

In a first step the method 600 comprises receiving 602 from a first client node, an accumulated error associated with differences between values of one or more parameters of the model between a first epoch of training and a second epoch of training performed by the first client node. In a second step the method 600 may comprise using 604 the accumulated error to determine whether to instruct the first client node to send the second update to the model to the server node.

In step 604 the method may comprise instructing the first client node to send the second update to the model to the server node if the accumulated error is greater than a first threshold.

The method 600 may further comprise receiving from the first client node, a distance measure between the values of the one or more parameters of the local model after a first epoch of training and the one or more parameters of the local model after a second epoch of training, and instructing the first client node to send the second update to the model to the server node if the distance measure is greater than a second threshold.

The accumulated error, distance measure, first threshold and second threshold were all described in detail above with respect to the method 300 and the detail therein will be appreciated to apply equally to the method 600.

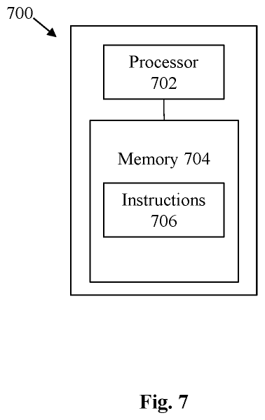

Turning now to FIG. 7 which illustrates a server node according to some embodiments herein. As described above, the server node 700 acts as a master in a distributed machine learning process for training the model, and co-ordinates training of the model amongst a plurality of client nodes that act as workers in the distributed machine learning process.

The server node is configured to perform the method 800 described below. The server node may comprise a processor, 702, and a memory 704. The memory comprises instruction data representing a set of instructions 706. The processor is configured to communicate with the memory and to execute the set of instructions. The set of instructions, when executed by the processor, may cause the processor to perform the method 800 described below.

Processors, memories and instructions were all described above with respect to the first client node 200 and the detail therein will be appreciated to apply equally to the processor 702, memory 704 and instructions 706.

The server node may be referred to as a global orchestrator node, or parameter server. The server node may be a network node. Examples of network nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC), or any future network architecture, such as a Sixth Generation network (6G).

In some embodiments, the server node is an edge server node. For example, an NWDAF as described above with respect to FIG. 5. In other embodiments, the server node is an Operations, Administration, and Maintenance (OAM) node. It will be appreciated however that these are merely examples and that the server node may be any node in the network suitable for performing the functionality described herein.

The server node may be configured to perform the method 800. The method 800 is a computer implemented method performed by a server node in a communications network, wherein the server node acts as a master in a distributed machine learning process for training a model, and co-ordinates training of the model amongst a plurality of client nodes that act as workers in the distributed machine learning process. In a first step 802 the method 800 comprises instructing a first client node to perform a first epoch of training on a local copy of the model to obtain a first update to the model. In a second step 804 the method 800 comprises instructing the first client node to perform a second epoch of training on the local copy of the model to obtain a second update to the model. In a third step 806 the method 800 comprises receiving the second update to the model from the first client node if an accumulated error associated with differences between values of one or more parameters of the model between the first epoch and the second epoch of training is greater than a first threshold.

Step 802 may comprise sending a message to the first client node to instruct the first client node to create a first local copy of the (global) model and perform the first epoch of training on the first local copy of the model.

The first client node and any other client nodes in the distributed learning process may perform the method 200 and send the outcome of the local training to the server node (according to the criteria outlined above with respect to step 308 of the method 300).

The server node may receive a first update from the first client node and/or one or more updates from other client nodes in the distributed learning process. the server may then aggregate the updates received from the plurality of client nodes (e.g. the first client node and/or one or more updates from other client nodes in the distributed learning process).

In step 804, the server instructs the first client node to perform a second epoch of training on a second local copy of the model (e.g. the updated global model) to obtain a second update to the model. The second local copy of the model is a copy of the global model that has been updated with the aggregated updates received from the client nodes in the first epoch of training.

The first client node creates a second local copy of the model and performs the second epoch of training according to step 304 to obtain a second update to the model. The first client node then performs steps 306 and 308 of the method 300. From the perspective of the server 700, the server then receives the second update to the model from the first client node if an accumulated error associated with differences between values of one or more parameters of the model between the first epoch and the second epoch of training is greater than a first threshold.

Alternatively or additionally, the server node may receive the second update to the model from the first client node if a distance measure between the values of the one or more parameters of the local model after the first epoch of training and the one or more parameters of the local model after the second epoch of training, is greater than a second threshold.

The accumulated error, distance measure, first threshold and second threshold were all described in detail above with respect to the method 300 and the detail therein will be appreciated to apply equally to the method 800.

As described above, the server node may also request that the client node uploads the second update. For example, the server node may determine a difference in the one or more parameter values of the global copy of the model stored at the server node and the latest (e.g. last) model update received from the respective client node. The server node may then request the second model update from the first client node if the first client node is in a subset of the plurality of client nodes having difference values that are in the highest x percentile of difference values, x being a configurable value between 0 and 100.

In more detail, the server node may compute Δ_{i,t+1}=∥wₜ₊₁−w̅_{i,t+1}∥ for all clients. Here, w̅_{i,t} is the latest (e.g. last) values that NWDAF received from client i (equal to w_{i,t+1} if the client uploaded its parameter/gradient and it is received by the NWDAF). The server node may then sort them, and request the top X percentile of them to upload their data in the next iteration. As an example, the top 5 percent may be selected, however, the percentile could be changed to a higher number at the expense of higher upload overhead in the next iteration.

In this way, the server node tracks the global drift of all models/gradients and will force some clients with the highest difference to upload in the next round, should their data be necessary. This allows the server node to proactively take a global view on which client nodes are likely to have updates that are most relevant to the model. In other words, which client nodes are likely to have updates that will lead to the fastest convergence of the model.

In many distributed learning algorithms, such as FL, the server node performs a simple averaging of the parameters it receives in the uplink. However, herein, using a global view (having access to parameters of all clients, not just one), the server can assess the importance of a parameters of individual clients to the global model update. In the case of non-IID data, the server can track the deviations of models of individual clients from the global model, and use that as a base to guide client selection, so as to avoid big deviations (which may be required for convergence of the algorithm).

Turning now to other embodiments, the first and second thresholds may be set by the server node so as to control the number of updates that are received in each epoch of training, whilst still ensuring convergence of the global model. In some embodiments, the values of the first threshold and the second threshold are set using reinforcement learning. For example, the method 800 may comprise determining a value for the first threshold and/or the second threshold, using a Reinforcement Learning, RL, agent configured to output the first threshold and/or the second threshold as an action, wherein the RL agent receives a reward based on a reward function that positively rewards actions that lead to improved convergence of a global copy of the model at the server node, and negatively rewards actions that lead to increased transmissions of model updates from the plurality of client nodes.

In some embodiments, the reward function is a negative sum of a total number of model updates received by the plurality of client nodes, and the final objective value. In this sense, the final objective value refers to loss function of the ML task, for example, the objective function could be, for instance, cross entropy in classification or mean squared error in regression.

The skilled person will be familiar with reinforcement learning and reinforcement learning agents, however, briefly, reinforcement learning is a type of machine learning process whereby a reinforcement learning agent (e.g. algorithm) is used to perform actions on a system (such as a communications network) to adjust the system according to an objective (which may, for example, comprise moving the system towards an optimal or preferred state of the system). The reinforcement learning agent receives a reward based on whether the action changes the system in compliance with the objective (e.g. towards the preferred state), or against the objective (e.g. further away from the preferred state). The reinforcement learning agent therefore adjusts parameters in the system with the goal of maximising the rewards received.

Put more formally, a reinforcement learning agent receives an observation from an environment in state S and selects an action to maximize the expected future reward r. Based on the expected future rewards, a value function V for each state can be calculated and an optimal policy π that maximizes the long term value function can be derived.

In the context of this disclosure, in some embodiments herein, a reinforcement learning agent may be used to set the values of the first and/or second thresholds. These embodiments enable the server node to broadly control the number of updates sent by the plurality of clients nodes in each epoch of training and to provide some control over the rate of convergence of the global model, without increasing overhead on the network.

In such embodiments, the “environment” may comprise e.g. the network conditions in the communications network, the conditions in which the communications network is operating and/or the conditions in which devices connected to the communications network are operating. At any point in time, the communications network is in a state S. The “observations” comprise values relating to the process in the communications network that is being managed by the reinforcement learning agent (e.g. degree of convergence of the model, accuracy of the model etc) and the “actions” performed by the reinforcement learning agents are the adjustments made by the reinforcement learning agent to the first threshold and/or the second threshold.

Thus, the RL agent may take as input state values, one or more of: computational resource available to the first client node; power available to the first client node; communication resource available to the first client node; and channel conditions between the first client node and the server node. The RL agent may further take as input the accumulated error, and/or or the distance measure.

In more detail, as an example, episodic reinforcement learning may be used where each episode is an instant of distributed AI problem. The RL model may be trained at the cloud and then deployed at the server node (e.g. at OAM and NWDAF). Actions would be determining values for the parameters (αₜ, βₜ)ₜ.

In some embodiments, (αₜ, βₜ)ₜ may be set for all worker nodes in the distributed machine learning process. In other examples, different values of (αₜ, βₜ)ₜ may be set for each worker node (e.g. on an individual basis).

As an example, the state may comprise one or more of: (1) Δ_{i,t+1}, (2)∥w_{i,t+1}−w_{i,t}∥, (3) e_{i,t}, (4) channel conditions, and (5) local available resources (computation, power, communication). The local available resources may be normalized to the maximum available. By adding these variables to the state, the RL agent considers the importance of local data, uses global view to guide local decision making, and finally looks at the instantaneous channel conditions to decide if a client should upload its data in this iteration.

The reward is given at the end of the episode. As an example, the reward may be calculated as a negative weighted sum of (1) the total number of uploads and (2) final objective value. The negative is because we normally maximize the reward in RL, and maximizing our reward means minimizing the number of uploads and the objective function (e.g., test accuracy).

The RL agent is thus configured to set the first and second thresholds at values that balance the need to obtain sufficient updates to ensure convergence of the global model and meet the training requirements therefore, whilst also reducing network overhead associated with sending model parameters across the network. The server node thus adaptively updates the first and/or second thresholds to ensure convergence.

This addresses the importance of communication links to the efficiency of distributed learning processes: All clients should exchange their messages through some communication resources, which are affected by the instantaneous transmission rate, among other factors.

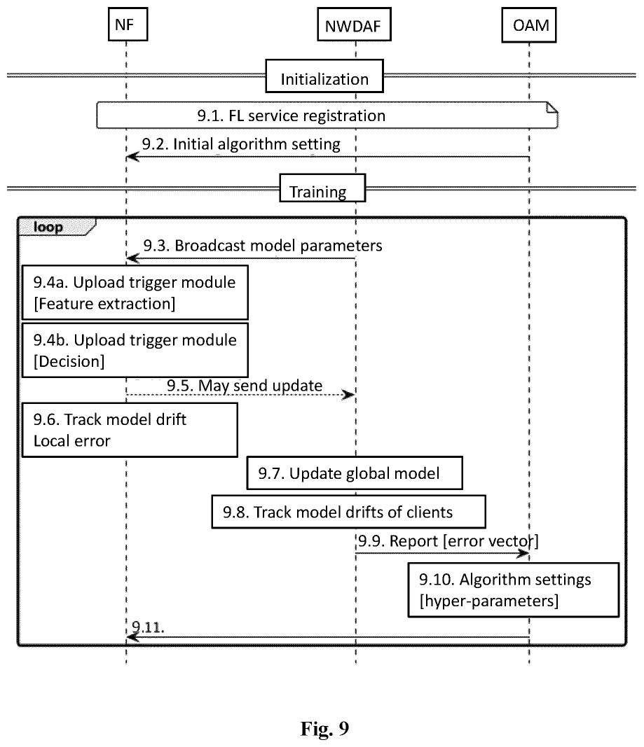

Turning now to FIG. 9 which shows a signal diagram according to some embodiments herein. In this embodiment the first client node is a network function (NF) and the server node is a NWDAF. This example gives an overview of a Federated Learning with client scheduling. The NF may be located inside a UE. Model changes/drift will be tracked locally and globally to improve the local update trigger and maintain the global convergence. In this example, the following messages are sent.

Step 9.1: FL Service Registration. During FL service registration and initial algorithm setting, the clients, NWDAF, and OAM register the new distributed training request and set some global variables, including initializations of the distributed optimization algorithm.

Step 9.2: Initial settings for the model are sent to the NF.

Steps 9.3-9.11 show the steps that take place in each epoch of training.

Step 9.3: the server node (which can be in NWDAF) will broadcast new global parameter to all clients.

Step 9.4: Each client performs the method 300, and performs step 304 to determine an update to the model (as a result of local training). A module that acts as an “Upload Trigger Module”, then decides if it should upload its update to the NWDAF or not. In this embodiment, this decision is a function of the distance parameter and the accumulated error. Step 9.4 has two parts: a) feature extraction, e.g. determination of the distance parameter and the accumulated error according to step 306 described above, and b) decision making as to whether the updates to the model obtained at each client should be sent to the NWDAF, according to step 308 above. In one embodiment, both a) and b) are performed locally at the client nodes. This is shown in FIG. 9 whereby the NF performs both steps 9.4a and 9.4b (corresponding to steps 306 and 308 of the method 300 respectively). This decision depends on the local data and local smoothness of the objective function as described above with respect to the method 300.

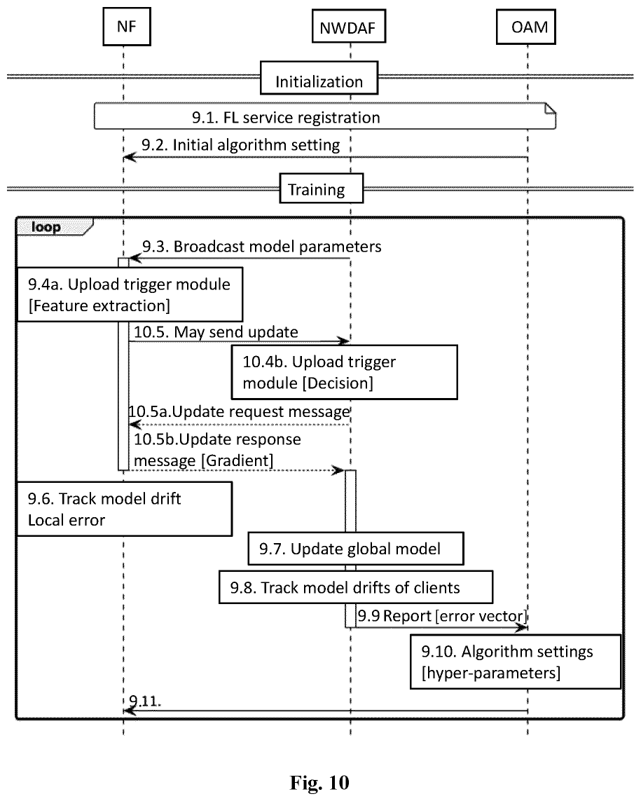

FIG. 10, illustrates another embodiment where a) is done locally, e.g. the NF performs step 3-4 of the method 300, but sends the distance measure and the accumulated error to the NWDAF. b) is then performed globally, for instance in the NWDAF.

In another embodiment, each client can compute new gradient and run similar policies of Upload Trigger Module on the new gradient and upload it only when the changes are significant. In this case, the parameter server updates the global model based on the gradients it received from clients (like generic distributed gradient descent algorithm).

Step 9.5: If it is decided to send then the local parameters are sent to NWDAF. Otherwise, nothing happens at this step.

Step 9.6: It then updates the local error vector (a drift between the existing local model and the one sent to NWDAF).

Steps 9.7 and 9.8: Upon receiving updates of the clients, NWDAF will update the global model and computes the drift of each individual client. In one embodiment, the NWDAF takes an average over only the parameters/gradient s that it received from participating clients and updates the global model accordingly. In another embodiment, the NWDAF takes an average over all models/gradients. In this case, it uses the most recent values it received from each client. Clearly, some of these values could be outdated if the corresponding client did not upload in this round or if its data did not receive by the orchestrator due to channel failure or other communication problems.

Step 9.9: NWDAF will send this to the orchestrator (Orchestrator and Management (OAM)) for further analysis.

Step 9.10: OAM will then update the distributed AI algorithm settings including thresholds of box 4 in FIG. 1. In Steps 9.8-9.10, a global view is then used to guide whether the NF should upload its updated. For example, the OAM may determine the model drifts of all clients and request in step 11 that a subset of clients with the highest drifts (e.g. the highest x percent of drift values) to upload their models in the next iteration.

The methods described above may be implemented in a wide variety of scenarios. For example, for use in training a model on a plurality of client nodes in the form of IoT devices. In such scenarios, the IoT devices may have battery constraints, and/or poor signal quality, making it computationally expensive to transmit updates after every epoch of training.

As another example, consider a use case where distributed learning is performed over local data available at a plurality of industrial IoT devices. Due to harsh wireless environments (e.g., due to metallic objects, radio frequency interference, humidity, and/or vibrations in usual factory settings), various IoT devices (i.e., client nodes in the distributed learning scheme) may experience different channel quality to the server at any given time. Moreover, the bandwidth is usually congested. In such a scenario, the methods herein may be used to train the model with fewer transmissions (e.g. of updates to the model from the clients to the server node). This can substantially improve network quality.

This is because, in embodiments where RL is used to set the first and second thresholds, the channel condition can be taken into consideration when setting the thresholds used to determine whether an update is to be uploaded. Furthermore, importance of the updates of every client can be assessed using both local information (e.g. in steps 306 and 308) and global information (e.g. through the server node asking the x percent of highest gradient clients to upload their updates) to decide on the uploads. The result is fewer uploads by clients which eliminates unnecessary communications and potentially co-channel interference and thereby substantially reduces the communication overhead while improving overall network quality. As only those updates that are most likely to add to the convergence of model are selected, this is achieved without loss of information in the training process.

Thus in summary, the methods herein: can reduce the total number of transmissions, latency, and energy consumption while achieving the same training accuracy; can reduce uplink interference by eliminating unnecessary uploads of the AI clients, thereby improving the UL performance of other communication services running in parallel; and can also reduce the number of resource blocks needed for the AI service, leaving more resources for other communication services running in parallel.

Turning now to other embodiments, in another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer implemented method performed by a first client node in a communications network, the first client node acting as a worker in a distributed machine learning process for training a model, the training being co-ordinated by a server node that acts as a master in the distributed machine learning process, the method comprising:
performing a first epoch of training on a first local copy of the model received from the server node to obtain a first update to the model;
performing a second epoch of training on a second local copy of the model received from the server node to obtain a second update to the model;
determining an accumulated error associated with differences between values of one or more parameters of the model between the first epoch and the second epoch of training; and
using the accumulated error to determine whether to send the second update to the model to the server node.

2. The first client node as in claim 28, wherein using the accumulated error to determine whether to send the second update to the model to the server node comprises:
sending the second update to the model to the server node if the accumulated error is greater than a first threshold.

3. The first client node as in claim 28, using the accumulated error to determine whether to send the second update to the model to the server node comprises:
sending the accumulated error to a Network Data Analytics Function, NWDAF node in the communications network; and
receiving from the NWDAF node, an indication of whether the first client node should send the second update to the model to the server node based on the accumulated error.

4. The first client node as in claim 28, wherein the accumulated error is a vector aggregation of values of the one or more parameters obtained as a result of the first epoch of training and the second epoch of training.

5. The first client node as in claim 4, wherein the accumulated error further comprises a vector aggregation of values of the one or more parameters obtained as a result of one or more other epochs of training preceding the first epoch of training, wherein the one or more other epochs of training all occurred since the first client node last sent an update to the server node as part of the distributed learning process.

6. The first client node as in claim 28, wherein the accumulated error associated with the first epoch of training, e_{i,t}, is set to:
zero, if following the first epoch of training, the first client node sends the first update to the model to the server node; or
to w_{i,t}, if following the first epoch of training, the first client node does not send the first update to the model to the server node, wherein w_{i,t} are the values of the one or more parameters of the local copy of the model following the first epoch of training.

7. The first client node as in claim 6, wherein the accumulated error associated with the second epoch of training, e_{i,t+1}, is set to:
zero, if following the second epoch of training, the first client node sends the second update to the model to the server node; or
to e_{i,t+1}=e_{i,t}+w_{i,t+1} if, following the second epoch of training, the first client node does not send the first update to the model to the server node, wherein w_{i,t+1} are the values of the one or more parameters of the local copy of the model following the second epoch of training.

8. The first client node as in claim 7, wherein using the accumulated error to determine whether to send the second update to the model to the server node comprises sending the second update to the server node if ∥e_{i,t}∥≥βₜ₊₁, wherein βₜ₊₁ represents the first threshold.

9. The first client node as in claim 8, wherein the first threshold is set dynamically by the server node after each epoch of training.

10. The first client node as in claim 28, wherein the processor is further caused to:
send the second update to the model to the server node if a distance measure between the values of the one or more parameters of the local model after the first epoch of training and the one or more parameters of the local model after the second epoch of training, is greater than a second threshold.

11. The first client node as in claim 28, wherein the processor is further caused to:
send a distance measure between the values of the one or more parameters of the local model after the first epoch of training and the one or more parameters of the local model after the second epoch of training to a Network Data Analytics Function, NWDAF node in the communications network; and
receive from the NWDAF node, an indication of whether the first client node should send the second update to the model to the server node, based on the distance measure.

12. The first client node as in claim 10, wherein the distance measure is determined according to:
∥w_{i,t+1}−w_{i,t}∥, wherein w_{i,t+1} are the values of the one or more parameters of the model following the second epoch of training and w_{i,t} are the values of the one or more parameters of the model following the first epoch of training.

13. The first client node as in claim 10, wherein the second threshold is set dynamically by the server node after each epoch of training.

14. The first client node as in claim 28, wherein the processor is further caused to:
send the second update to the model to the server node in response to a request from the server node for the second update.

15. The first client node as in claim 28, wherein the first client node is an industrial Internet of Things, IoT device.

16.-27. (canceled)

28. A first client node in a communications network, the first client node acting as a worker in a distributed machine learning process for training a model, the training being co-ordinated by a server node that acts as a master in the distributed machine learning process, the first client node comprising:
a memory comprising instruction data representing a set of instructions; and
a processor configured to communicate with the memory and to execute the set of instructions, the set of instructions, when executed by the processor, causing the processor to:
perform a first epoch of training on a first local copy of the model received from the server node to obtain a first update to the model;
perform a second epoch of training on a second local copy of the model received from the server node to obtain a second update to the model;
determine an accumulated error associated with differences between values of one or more parameters of the model between the first epoch and the second epoch of training; and
use the accumulated error to determine whether to send the second update to the model to the server node.

29.-31. (canceled)

32. A server node in a communications network, the server node acting as a master in a distributed machine learning process for training a model, and co-ordinates training of the model amongst a plurality of client nodes that act as workers in the distributed machine learning process, the server node comprising:
a memory comprising instruction data representing a set of instructions; and
a processor configured to communicate with the memory and to execute the set of instructions, wherein the set of instructions, when executed by the processor, cause the processor to:
instruct a first client node to perform a first epoch of training on a first local copy of the model to obtain a first update to the model;
instruct the first client node to perform a second epoch of training on a second local copy of the model to obtain a second update to the model; and
receive the second update to the model from the first client node if an accumulated error associated with differences between values of one or more parameters of the model between the first epoch and the second epoch of training is greater than a first threshold.

33.-42. (canceled)

43. The method as in claim 1, wherein using the accumulated error to determine whether to send the second update to the model to the server node comprises:
sending the second update to the model to the server node if the accumulated error is greater than a first threshold.

44. The method as in claim 1, wherein using the accumulated error to determine whether to send the second update to the model to the server node comprises:
sending the accumulated error to a Network Data Analytics Function, NWDAF node in the communications network; and
receiving from the NWDAF node, an indication of whether the first client node should send the second update to the model to the server node based on the accumulated error.

45. The method as in claim 1, wherein the accumulated error is a vector aggregation of values of the one or more parameters obtained as a result of the first epoch of training and the second epoch of training.
